(19) United States
(12) Patent Application Publication
(10) Pub. No.: US 2017/0066945 A1
(43) Pub. Date: Mar. 9, 2017

(54) CONDUCTIVE ADHESIVE COMPOSITION, METHOD FOR PRODUCING THE SAME, SEALANT AND DISPLAY PANEL

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Yongshan ZHOU, Beijing (CN); Yifeng QIN, Beijing (CN)

(21) Appl. No.: 15/122,583

(22) PCT Filed: Sep. 14, 2015
(86) PCT No.: PCT/CN2015/089525

§ 371 Date: Aug. 30, 2016

(30) Foreign Application Priority Data
Apr. 24, 2015 (CN) 201510202593.4

(51) Int. Cl. C09J 9/02; C08K 3/08; C08K 3/04; C09J 175/04; C09J 133/04; C09J 163/00; C09J 129/14; C09J 171/00; C09J 11/04; C08K 7/16

(52) U.S. Cl. CPC C09J 9/02; C09J 11/04; C08K 3/08; C08K 3/04; C08K 7/16; C09J 133/04; C09J 163/00; C09J 129/14; C09J 171/00; C09J 175/04; C08K 2003/0831; C08K 2003/0806; C08K 2003/085; C08K 2003/0812; C08K 2003/0862; C08K 2201/001

(57) ABSTRACT

The embodiments of the present disclosure relate to the field of display technologies and provide a conductive adhesive composition, a method for producing the same, a sealant and a display panel, so as to improve the dispersion evenness of conductive particles in the adhesive and ensure excellent conductivity of the conductive adhesive composition, as well as avoid influencing the normal throughput of the adhesive during coating when the doping percentage of conductive particles is high. The conductive adhesive composition comprises: a primary adhesive material; and carrier granules dispersed in the primary adhesive material and having conductive particles adsorbed thereon. The present disclosure is applicable to manufacture a conductive adhesive composition as well as a sealant and a display panel comprising the conductive adhesive composition.

### RELATED APPLICATIONS

The present application claims the benefit of Chinese Patent Application No. 201510202593.4, filed on Apr. 24, 2015, the entire disclosure of which is incorporated herein by reference.

### FIELD

The present disclosure relates to the field of display technologies, and in particular to a conductive adhesive composition, a method for producing the same, a sealant and a display panel.

### BACKGROUND ART

At present, conductive adhesive is an adhesive material capable of effectively bonding various materials while being electrically conductive. It is an adhesive material widely applied in the field of electronic device production, such as a material for forming a conductive thin film (e.g., a conductive circuit of a printed circuit board), a conductive adhesive for conductive adhesion (e.g., fixation of electronic components on conductive circuits, connection between the conductive circuits) between electronic components and so on.

As shown in FIG. 1, the main components of a conductive adhesive include a primary adhesive material 10 composed of a resin material, and conductive particles 20 such as gold balls, dispersed in the primary adhesive material 10 to conduct electricity.

A major problem existing in the prior art is that the conductive particles such as gold balls have a poor dispersivity in the primary adhesive material since they are apt to agglomerate. Even if the gold balls are stirred for a long time, their dispersivity is still very poor, which directly influences the overall conductivity of the conductive adhesive. Meanwhile, a long stirring time will also reduce the production efficiency.

In addition, when the doping percentage of the gold balls is high, not only will the stirring time be prolonged, but also the viscosity of the conductive adhesive will be increased, which will influence the throughput of the adhesive during coating.

### SUMMARY

Embodiments of the present disclosure provide a conductive adhesive composition, a method for producing the same, a sealant and a display panel, so as to improve the dispersion evenness of conductive particles in the adhesive and ensure excellent conductivity of the conductive adhesive composition, as well as avoid influencing the normal throughput of the adhesive during coating when the doping percentage of conductive particles is high.

To this end, the embodiments of the present disclosure adopt technical solutions as follows.

According to one aspect, the embodiments of the present disclosure provide a conductive adhesive composition. The conductive adhesive composition comprising a primary adhesive material. The conductive adhesive composition further comprises carrier granules dispersed in the primary adhesive material and having conductive particles adsorbed thereon.

Optionally, the carrier granules comprise on their surfaces first functional groups which are organophilic.

Furthermore optionally, the primary adhesive material is composed of a resin material. The first functional groups comprise at least one of amino, mercapto, vinyl, epoxy, cyano and methacryloyloxy.

Optionally, the carrier granules comprise on their surfaces second functional groups carrying positive charges or negative charges.

Based on that, optionally, the conductive particles are made of at least one material of gold, silver, copper, aluminum, nickel and tin.

Based on that, optionally, the conductive particles are spherical.

Based on that, optionally, the carrier granules are made of at least one material of carbon black, activated carbon, carbon nanotubes and molecular sieves.

According to another aspect, the embodiments of the present disclosure further provide a method for producing a conductive adhesive composition. The method comprises: forming carrier granules having conductive particles adsorbed thereon; and dispersing the carrier granules having conductive particles adsorbed thereon into the primary adhesive material.

Optionally, the step of forming carrier granules having conductive particles adsorbed thereon comprises: dispersing the conductive particles into a first solvent to form a dispersion liquid of conductive particles; dispersing the carrier granules into the dispersion liquid of conductive particles to adsorb the conductive particles; separating the carrier granules from the dispersion liquid of conductive particles; and drying the carrier granules to obtain the carrier granules having conductive particles adsorbed thereon.

Optionally, the method further comprises: prior to forming carrier granules having conductive particles adsorbed thereon, performing modification treatment on the carrier granules to expose adsorption channels within the carrier granules.

Furthermore, optionally, the step of performing modification treatment on the carrier granules to expose adsorption channels within the carrier granules comprises: dispersing the carrier granules into an acidic solvent; separating the carrier granules from the acidic solvent; washing the carrier granules until pH value is stable; and drying the carrier granules to obtain the carrier granules that have undergone modification treatment.

Optionally, the method further comprises: prior to dispersing the carrier granules having conductive particles adsorbed thereon into the primary adhesive material, performing a grafting treatment on the carrier granules such that the carrier granules comprise on their surfaces first functional groups which are organophilic.

Furthermore, optionally, the step of performing a grafting treatment on the carrier granules such that the carrier granules comprise on their surfaces first functional groups which are organophilic comprises: dispersing the carrier granules into a second solvent; heating the second solvent in which the carrier granules have been dispersed; adding a reaction solution having first functional groups into the second solvent; separating the carrier granules; and drying the carrier granules to obtain the carrier granules having the first functional groups on their surfaces.

Optionally, the method further comprises: prior to dispersing the carrier granules having conductive particles adsorbed thereon into the primary adhesive material, performing a grafting treatment on the carrier granules such that the carrier granules comprise on their surfaces second functional groups which carry positive charges or negative charges.

Furthermore, optionally, the step of performing a grafting treatment on the carrier granules such that the carrier granules comprise on their surfaces second functional groups which carry positive charges or negative charges comprises: dispersing the carrier granules into a third solvent; heating the third solvent in which the carrier granules have been dispersed; adding a reaction solution having second functional groups into the third solvent; separating the carrier granules; and drying the carrier granules to obtain the carrier granules having the second functional groups on their surfaces.

According to yet another aspect, the embodiments of the present disclosure further provide a sealant. The sealant comprises a photo-polymerizing agent. The sealant further comprises the conductive adhesive composition described above.

According to still another aspect, the embodiments of the present disclosure further provide a display panel. The display panel comprises an upper substrate and a lower substrate disposed oppositely. The display panel further comprises the sealant. The sealant is located between the upper substrate and the lower substrate.

Based on that, in the conductive adhesive composition provided by the embodiments of the present disclosure, since the conductive particles are adsorbed by the carrier granules, the conductive particles can be evenly dispersed into the primary adhesive material by virtue of the carrier granules. In this way, phenomena in the prior art such as agglomeration and increase in the particle size due to direct dispersion of the conductive particles such as gold balls into the primary adhesive material are avoided, and the overall conductivity of the conductive adhesive composition is improved, such that it can obtain a more excellent conductive adhesive effect when applied between electronic components. This is particularly useful for the case where the adhesion and conduction between upper and lower substrates of a self capacitance touch panel has a high requirement for conductivity.

Moreover, when the doping proportion of the conductive particles (i.e., the proportion of the conductive particles relative to the primary adhesive material) is high, since the conductive particles are dispersed into the primary adhesive material by being adsorbed onto the carrier granules, there will be no such problem in the prior art as high viscosity of the adhesive due to direct dispersion of a high doping proportion of conductive particles and thus influences on throughput of the adhesive.

### BRIEF DESCRIPTION OF DRAWINGS

In order to render the technical solutions in the embodiments of the present disclosure or in the prior art clearer, drawings to be used in the description of the embodiments or the prior art shall be introduced briefly in the following text. Apparently, the drawings described below are only a part of the embodiments of the present disclosure. For a person having ordinary skills in the art, other drawings can also be obtained according to these drawings on the premise that no inventive efforts are made.

FIG. 1 is a schematic structural view of a conductive adhesive provided in the prior art;

FIG. 2 is a schematic structural view of a conductive adhesive composition provided by the embodiments of the present disclosure;

FIG. 3 is an enlarged internal structural view of carrier granules having conductive particles adsorbed thereon;

FIG. 4 is a contrast view for the particle size distribution of carrier granules having conductive particles adsorbed thereon and that of conductive particles dispersed directly;

FIG. 5 is another enlarged internal structural view of carrier granules having conductive particles adsorbed thereon;

FIG. 6 is a flow diagram of a method for producing a conductive adhesive composition provided by the embodiments of the present disclosure;

FIG. 7 is another schematic structural view of a conductive adhesive composition provided by the embodiments of the present disclosure;

FIG. 8 is an effect view for modification and grafting on a conductive adhesive composition provided by the embodiments of the present disclosure; and

FIG. 9 is a schematic structural view of a sealant provided by the embodiments of the present disclosure.

### DETAILED DESCRIPTION OF EMBODIMENTS

Reference signs:

01-conductive adhesive composition; 10-primary adhesive material; 20-conductive particle; 30-carrier granule; 301-first functional group; 02-sealant; 03-photo-polymerizing agent.

The technical solutions in the embodiments of the present disclosure shall be described clearly and completely in the following text with reference to the drawings in the embodiments of the present disclosure. Apparently, the embodiments described below are only a part of the embodiments of the present disclosure, rather than all of them. Based on the embodiments in the present disclosure, all other embodiments obtainable by a person having ordinary skills in the art without making inventive efforts shall fall within the protection scope of the present disclosure.

It should be noted that, since sizes of each structure involved in the embodiments of the present disclosure are usually on a scale of millimeter (mm), micron (μm), submicron (100 nm˜1.0 μm) and nanometer (nm), the sizes of each structure in the drawings of the embodiments of the present disclosure are exaggerated for clarity and hence do not represent their real sizes.

Moreover, those skilled in the art should also understand that, the structures shown in all drawings of the present disclosure do not limit the specific structural composition of a conductive adhesive composition 10 and/or a sealant 02 provided by the embodiments of the present disclosure as follows, but instead they are only used for reflecting structures related to the inventive concept so as to clearly describe the present disclosure, and other existing structures unrelated to the inventive concept are not reflected or only partly reflected in the drawings.

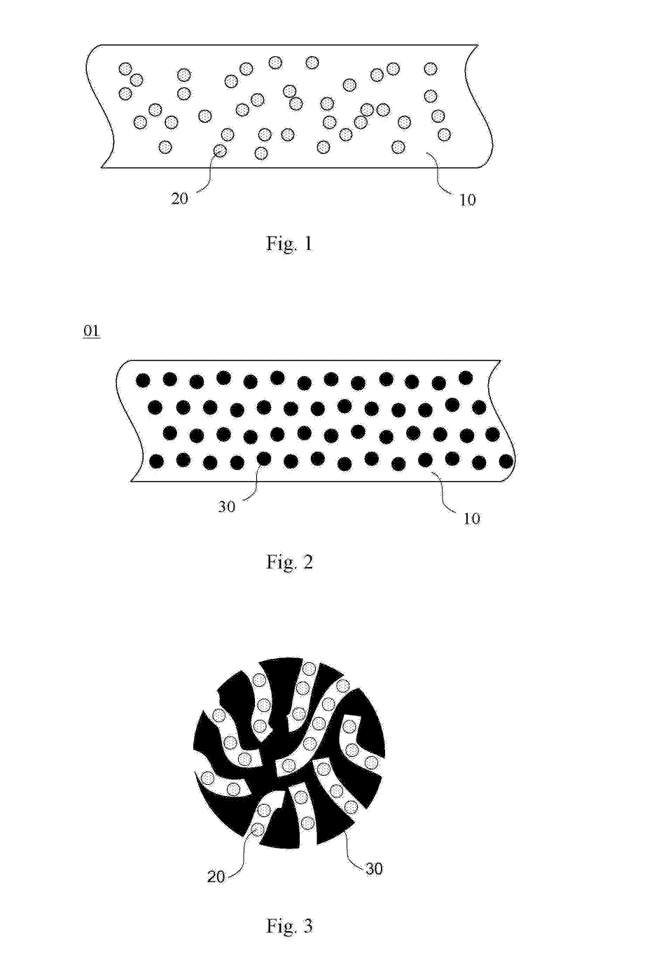

The embodiments of the present disclosure provide a conductive adhesive composition 01. As shown in FIG. 2, the conductive adhesive composition 01 comprising: a primary adhesive material 10; and carrier granules 30 dispersed into the primary adhesive material 10 and having conductive particles 20 (not shown) adsorbed thereon.

It should be noted that, the primary adhesive material 10 can comprise a resin material, but is not limited thereto. There are many choices for the resin material. For example, it can be acrylic resin, epoxy, bisphenol A epoxy resin, polyvinyl butyral resin, diethylene glycol monobutyl ether acetate, carboxyl group-containing urethane resin and so on.

It should also be noted that, the so-called “granules” refer to geometries having a characteristic shape within a range of a certain size. The certain size here usually falls between millimeters and nanometers. Therefore, the carrier granules 30 namely refer to granules having a small size scale. Their specific microscopic shape is not limited to spherical. But instead, they can be in various shapes, which will not be specifically limited.

Here, the carrier granules 30 have a function of adsorbing micro particles, and can be made of, e.g., an adsorption material. That is, the carrier granules 30 have a larger specific surface area, more suitable aperture structures and surface microstructures as compared to an adsorbate, and have a strong adsorption capacity with respect to the adsorbate (i.e., conductive particles).

For example, the carrier granules 30 can comprise at least one material of carbon black, activated carbon, carbon nanotubes and molecular sieves (i.e., silicate or aluminosilicate in a crystalline state), but are not limited thereto.

Considering the fact that the conductive adhesive composition 01 is usually applied to the sealant material for cell alignment between upper and lower substrates of a display product, the carrier granules 30 are preferably made of a carbon black material which is readily available with a smaller particle size and a darker color capable of preventing light leakage.

Again, it should be noted that, the conductive particles 20 can comprise at least one material of gold (Au), silver (Ag), copper (Cu), aluminum (Al), nickel (Ni) and tin (Sn), but are not limited thereto. The conductive particles 20 can have but are not limited to a spherical shape, a scaly shape or a branched shape.

It should be pointed out that, the conductive particles 20 can be adsorbed by the carrier granules 30 in a form as shown in FIG. 3. That is, the conductive particles 20 are adsorbed into channels such as internal apertures of the carrier granules 30. In such an adsorption form, the conductive particles 20 are usually in a microscopic shape of structures such as spheres, and have a size smaller than the channels of the carrier granules 30.

Additionally or alternatively, the conductive particles 20 can also be adsorbed by the carrier granules 30 in such a form that a part of the conductive particles 20 are adsorbed into channels such as internal apertures of the carrier granules 30 or onto surface microstructures. That is, the size of the conductive particles 20 is close to the channels of the carrier granules 30 and the surface microstructures. In this case, the conductive particles 20 are usually in a microscopic shape of structures such as scales or branches. Obviously, the present disclosure will not be specifically limited in this regard, as long as the conductive particles 20 are adsorbed by the carrier granules 30 such that the adsorbed conductive particles 20 are dispersed into the primary adhesive material 10 by virtue of the carrier granules 30.

Here, considering the fact that the adsorption of the carrier granules will be more facilitated when the conductive particles 20 are in a shape of spheres as compared to a shape of structures such as scales or branches, the conductive particles 20 are preferably spherical.

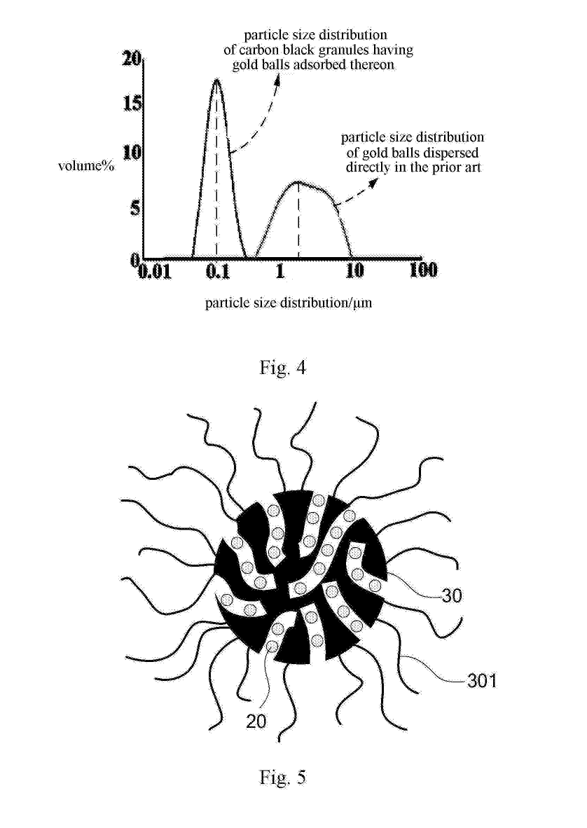

Based on that, FIG. 4 is a contrast view, when the carrier granules 30 are carbon black granules and the conductive particles 20 are gold balls, for the particle size of the carbon black granules having the gold balls adsorbed thereon in the conductive adhesive combination 01 provided by the embodiment of the present disclosure and that of the gold balls dispersed directly into the primary adhesive material in the prior art. As can be seen, an average particle size distribution for the carbon black granules having gold balls adsorbed thereon falls in the vicinity of 0.1 μm, while the particle size distribution for the gold balls directly dispersed into the primary adhesive material falls in the vicinity of 2-3 μm as the gold balls agglomerate by themselves. As a result, the particle size is obviously larger by one scale than the carbon black granules having gold balls adsorbed thereon in the embodiments of the present disclosure.

Based on that, in the conductive adhesive composition 01 provided by the embodiments of the present disclosure, since conductive particles 20 are adsorbed by carrier granules 30, the conductive particles 20 can be more evenly dispersed into the primary adhesive material by virtue of the carrier granules 30. In this way, phenomena in the prior art such as agglomeration and increase in the particle size due to direct dispersion of the conductive particles such as gold balls into the primary adhesive material is avoided, and the overall conductivity of the conductive adhesive composition 01 is improved, such that it can obtain a more excellent conductive adhesive effect when applied between electronic components. This is particularly useful for the case where the adhesion and conduction between upper and lower substrates of a self capacitance touch panel has a high requirement for conductivity.

Moreover, when the doping proportion of the conductive particles 20 (i.e., the proportion of the conductive particles 20 relative to the primary adhesive material 10) is high, since the conductive particles 20 are dispersed into the primary adhesive material 10 by being adsorbed onto the carrier granules 30, there will be no such problems in the prior art as high viscosity of the adhesive due to direct dispersion of a high doping proportion of conductive particles and thus influences on throughput of the adhesive.

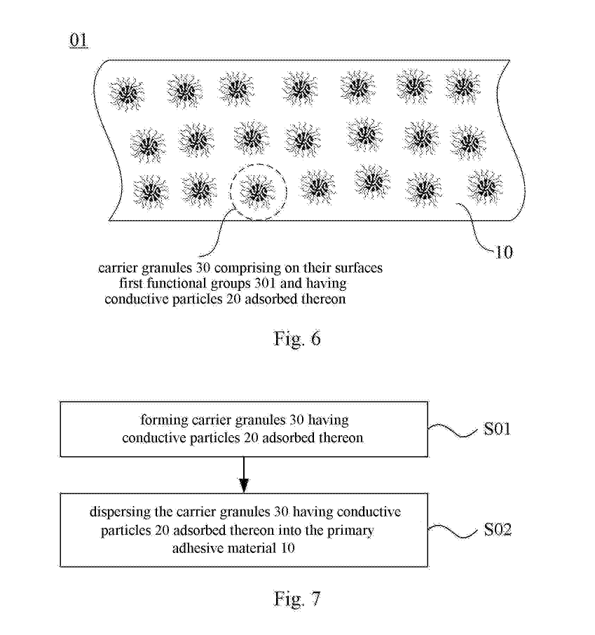

Furthermore, as shown in FIG. 5 and FIG. 6, the carrier granules 30 comprise on their surfaces first functional groups 301 (not shown in FIG. 6) which are organophilic. The first functional groups 301 are used for enhancing adhesion of the primary adhesive material 10, to improve the adhesive force between the conductive adhesive composition 01 and the substrate to be coated.

Based on that, since the primary adhesive material 10 is usually mainly composed of a resin material, the first functional groups can comprise but are not limited to at least one of amino, mercapto, vinyl, epoxy, cyano and methacryloyloxy.

It should be noted that, the above groups are all branched groups of coupling agents or silane coupling agents having organophilic characteristics and being apt to react with resin materials. So, the adhesive force between the conductive adhesive composition 01 and the substrate to be coated is greatly enhanced. Meanwhile, since the carrier granules 30 have the first functional groups 301 which are organophilic on their surfaces, the dispersion of the carrier granules 30 per se into the primary adhesive material 10 is considerably improved. In this case, the dispersion of the conductive particles 20 into the primary adhesive material 10 is further improved, such that the conductive adhesive composition 01 formed has a better conductivity and a better adhesive effect will be obtained when applied to electronic devices.

Furthermore, the carrier granules 30 comprise on their surfaces second functional groups carrying positive charges or negative charges.

Here, second functional groups carrying negative charges are used as an example. The second functional groups can comprise but are not limited to a bivalent sulfate group (SO₄²⁻), a trivalent nitrate group (NO³⁻) and so on.

Since the carrier granules 30 comprise on their surfaces second functional groups carrying positive charges or negative charges, in light of the repellency of surface charges, it is hard for the carrier granules 30 to agglomerate after being dispersed into the primary adhesive material 10. That is, the dispersivity of the conductive particles 20 is further improved.

It should be noted that, the skilled persons in the art can make flexible adjustment based on the specific structural components of the conductive adhesive composition 01. That is, the carrier granules 30 can comprise on their surfaces the first functional groups 301 and/or the second functional groups, which will not be specifically limited.

Based on that, the embodiments of the present disclosure further provide a method for producing the conductive adhesive composition 01. As shown in FIG. 7, the method comprises the following steps: S01, forming carrier granules 30 having conductive particles 20 adsorbed thereon; and S02, dispersing the carrier granules 30 having conductive particles 20 adsorbed thereon into the primary adhesive material 10.

Furthermore, the above step S01 can specifically comprise the following sub-steps: S11, dispersing the conductive particles 20 into a first solvent to form a dispersion liquid of conductive particles; S12, dispersing the carrier granules 30 into the dispersion liquid of conductive particles to adsorb the conductive particles 20; S13, separating the carrier granules 30 from the dispersion liquid of conductive particles; and S14, drying the carrier granules 30 to obtain the carrier granules 30 having the conductive particles 20 adsorbed thereon.

It should be noted that, the dispersion in step S11 is performed preferably by ultrasonic waves, so as to improve the dispersion evenness of the conductive particles 20 into the first solvent as much as possible. In this way, the adsorption efficiency of the carrier granules 30 will be promoted subsequently.

The first solvent functions to prevent the conductive particles 20 from settling and agglomerating, so as to form a stable suspension. It can be, for example, a conventional dispersing agent such as a polymeric dispersant.

In step S13, the carrier granules 30 can be preferably separated from the dispersion liquid of conductive particles by a high-speed centrifuge.

In step S14, in order to prevent a solid phase reaction of the carrier granules 30 due to a high temperature which then gives rise to agglomeration of the granules, the temperature and time for drying should be flexibly adjusted based on a mass of the carrier granules 30, and supplemented by a drying approach with a stepwise rising temperature.

Here, carrier granules 30 composed of carbon materials such as carbon black, activated carbon and carbon nanotube are taken as an example. Since the above materials will be converted into gaseous carbon dioxide after high-temperature heating, the following method can be adopted to confirm conveniently and rapidly whether the carrier granules have adsorbed the conductive particles 20.

The carrier granules 30 obtained from step S11 to step S14 are placed and fired in a heating device such as a muffle furnace, so as to remove the carbon materials such as carbon black, activated carbon and carbon nanotube, and the solid substance left is namely the conductive particle material.

Of course, for a case where the carrier granules 30 are composed of other materials such as molecular sieves, test instruments such as SEM (scanning electron microscope) can be also be adopted for characterizing in a more professional manner whether the carrier granules 30 have adsorbed the conductive particles 20. And if so, detailed structural information such as the distribution state of the conductive particles 20 after being adsorbed will also be characterized.

Here, the carrier granules 30 are usually composed of materials such as carbon black, activated carbon, carbon nanotubes and molecular sieves, that have a larger specific surface area, more suitable aperture structures and surface microstructures, as well as a stronger adsorption capacity with respect to the adsorbate. Due to an electrostatic adsorption effect, the carrier granules 30 will adsorb a plurality of impure ions on their surfaces, which not only block adsorption channels therein, but also introduce impurities into the conductive adhesive composition 01, thereby influencing its performance.

Therefore, furthermore, the method for producing a conductive adhesive composition 01 further comprises: prior to the above step S01, performing modification treatment on the carrier granules 30 to expose adsorption channels within the carrier granules 30.

The above step can specifically comprise the following sub-steps: S21, dispersing the carrier granules 30 into an acidic solvent; S22, separating the carrier granules 30 from the acidic solvent; S23, washing the carrier granules 30 until pH value is stable; and S24, drying the carrier granules 30 to obtain carrier granules that have undergone modification treatment.

It should be noted that, the acidic solvent can be for example an ordinary modification agent such as nitric acid, and the reaction time and reaction temperature can be flexibly adjusted based on different carrier granules 30 and acidic solvents, which will not be specifically limited.

pH value is a value representing acidic or alkaline degree of a solution. In the step S23, “washing . . . until pH value is stable” means washing the carrier granules 30 by deionized water (i.e., pure water with impurities in ionic form removed) until pH value of the deionized water after washing does not change any more or changes with a quite little amplitude.

Here, since the carrier granules 30 are dispersed into the acidic solvent prior to step S23, pH value after step S23 is stable correspondingly within a value range on the acidic side.

It should also be noted that, in step S24, the carrier granules 30 can be placed in an oven and dried and activated under a temperature condition of 120° C., so as to expose the adsorption channels within the carrier granules 30, i.e., to accomplish modification treatment on the carrier granules 30.

Here, since the carrier granules 30 may agglomerate in a small degree during drying, a glass rod can be used for slightly grinding them so as to reduce the degree of agglomeration.

Again it should be noted that, factors such as feed ratio, modifier (i.e., the acidic solvent) concentration, stirring speed, reaction time, reaction temperature and activation temperature and time during the reaction will all influence the effect of the surface modification on the carrier granules 30. And thus, the modification effect can be flexibly adjusted according to each of these influencing factors, to which no specific limitation shall be made.

Furthermore, the method for producing a conductive adhesive composition 01 further comprises: prior to the step S02, performing a grafting treatment on the carrier granules 30 such that the carrier granules 30 comprise on their surfaces first functional groups 301 which are organophilic. The first functional groups 301 are used for enhancing the adhesion of the primary adhesive material 10.

It should be noted that, since the primary adhesive material 10 is usually made of a resin material, the first functional groups 301 can comprise but are not limited to at least one of amino, mercapto, vinyl, epoxy, cyano and methacryloyloxy.

The above groups are all branched groups of coupling agents or silane coupling agents having organophilic characteristics and being apt to react with resin materials. So the adhesive force between the conductive adhesive composition 01 and the substrate to be coated is greatly enhanced. Meanwhile, since the carrier granules 30 have the first functional groups 301 which are organophilic on their surfaces, the dispersion of the carrier granules 30 per se into the primary adhesive material 10 is considerably improved. In this case, the dispersion of the conductive particles 20 into the primary adhesive material 10 is further improved, such that the conductive adhesive composition 01 formed has a better conductivity and a better adhesive effect will be obtained when applied to electronic devices.

It should also be noted that, the step of performing a grafting treatment on the carrier granules 30 can be implemented either before or after the step of performing modification treatment on the carrier granules 30 to expose adsorption channels within the carrier granules 30, to which no specific limitation shall be made.

Furthermore, the step of performing a grafting treatment on the carrier granules 30 such that the carrier granules 30 comprise on their surfaces first functional groups 301 which are organophilic specifically comprises the following sub-steps: S31, dispersing the carrier granules 30 into a second solvent; S32, heating the second solvent in which the carrier granules 30 have been dispersed; S33, adding a reaction solution having first functional groups 301 into the second solvent; S34, separating the carrier granules 30; and S35, drying the carrier granules 30 to obtain the carrier granules 302 having the first functional groups 301 on their surfaces.

Here, the second solvent functions to prevent the carrier granules 30 from settling and agglomerating, so as to form a stable suspension. It can be, for example, a conventional dispersing agent such as a polymeric dispersant.

Each of the above sub-steps will be described below in detail by taking the case in which the first functional groups 301 to be grafted comprise at least one of amino, mercapto, vinyl, epoxy, cyano and methacryloyloxy as an example.

S310, placing a certain mass of carbon black granules into a three-necked flask, and adding an appropriate volume of polymeric dispersant, to disperse them for a certain time by ultrasonic wave oscillation.

S320, heating by a heating mantle the polymeric dispersant in which the carbon black granules have been dispersed to a certain temperature.

S330, with stirring at a certain rotational speed, slowly adding the coupling agent or silane coupling agent (i.e., a solution containing the desired first functional groups 301 to be grafted) into the solution formed in step S320. An appropriate ratio between them can be flexibly adjusted based on the specific reaction.

S340, separating by centrifugal washing the polymeric dispersant and the coupling agent or silane coupling agent that has not been reacted from the carrier granules 30.

S350, placing the separated carrier granules 30 into a Petri dish and drying them in an oven at a certain temperature, so as to obtain carrier granules 302 having the first functional groups 301 on their surfaces.

Factors such as feed ratio, grafting agent (i.e., the second solvent) concentration, stirring speed, reaction time and reaction temperature during the reaction will all influence the effect of the surface grafting on the carrier granules 30. And thus, the grafting effect can be flexibly adjusted according to each of these influencing factors, to which no specific limitation shall be made.

Furthermore, the method for producing a conductive adhesive composition 01 further comprises: prior to the step S02, performing a grafting treatment on the carrier granules 30 such that the carrier granules 30 comprise on their surfaces second functional groups which carry positive charges or negative charges.

Second functional groups carrying negative charges are used as an example. The second functional groups can comprise but are not limited to a bivalent sulfate group (SO₄²⁻), a trivalent nitrate group (NO³⁻) and so on.

Since the carrier granules 30 comprise on their surfaces second functional groups carrying positive charges or negative charges, in light of the repellency of surface charges, it is hard for the carrier granules 30 to agglomerate after being dispersed into the primary adhesive material 10. That is, the dispersivity of the conductive particles 20 is further improved.

It should be noted that, the step of performing a grafting treatment on the carrier granules 30 can be implemented either before or after the step of performing modification treatment on the carrier granules 30 to expose adsorption channels within the carrier granules 30, to which no specific limitation shall be made.

Furthermore, the step of performing a grafting treatment on the carrier granules 30 such that the carrier granules 30 comprise on their surfaces second functional groups which carry positive charges or negative charges specifically comprises the following sub-steps: S41, dispersing the carrier granules 30 into a third solvent; S42, heating the third solvent in which the carrier granules 30 have been dispersed; S43, adding a reaction solution having second functional groups into the third solvent; S44, separating the carrier granules 30; and S45, drying the carrier granules 30 to obtain the carrier granules 30 having the second functional groups on their surfaces.

Here, the third solvent functions to prevent the carrier granules 30 from settling and agglomerating, so as to form a stable suspension. It can be, for example, a conventional dispersing agent such as a polymeric dispersant.

Each of the above sub-steps will be described below in detail by taking the case in which the second functional groups to be grafted carry negative charges SO₄²⁻ as an example.

S410, placing a certain mass of carbon black granules into a three-necked flask, and adding an appropriate volume of polymeric dispersant, to disperse them for a certain time by ultrasonic wave oscillation.

S420, heating by a heating mantle the polymeric dispersant in which the carbon black granules have been dispersed to a certain temperature.

S430, with stirring at a certain rotational speed, slowly adding an appropriate concentration of ammonium persulfate and/or sulfuric acid solution into the solution formed in step S320. An appropriate ratio between them can be flexibly adjusted based on the specific reaction.

S440, separating by centrifugal washing the polymeric dispersant and the ammonium persulfate and/or sulfuric acid solution that has not been reacted from the carrier granules 30.

S450, placing the separated carrier granules 30 into a Petri dish and drying them in an oven at a certain temperature, so as to obtain carrier granules 302 having the second functional groups on their surfaces.

Factors such as feed ratio, grafting agent (i.e., the third solvent) concentration, stirring speed, reaction time and reaction temperature during the reaction will all influence the effect of the surface grafting on the carrier granules 30. And thus, the grafting effect can be flexibly adjusted according to each of these influencing factors, to which no specific limitation shall be made.

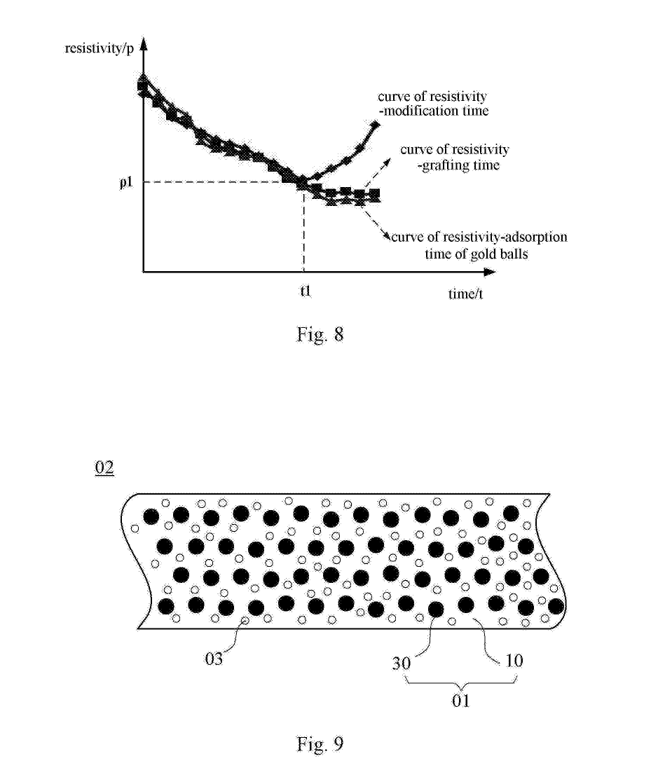

Based on that, FIG. 8 is an effect view for modification and grafting on the conductive adhesive composition provided by the embodiments of the present disclosure. The horizontal coordinates indicate time, and the vertical coordinates indicate resistivity of materials obtained from the test. Specific explanations are provided by taking the conductive particles 20 being gold balls as an example.

As can be seen from the figure, a “curve of resistivity-modification time” indicates a modification effect after the modification treatment on the carrier granules 30 to expose the adsorption channels within the carrier granules 30. As the modification time is prolonged, the resistivity of the carrier granules 30 having the conductive particles 20 adsorbed thereon exhibits a tendency to first decrease and then increase, because the modification treatment on the carrier granules 30 usually requires a certain drying treatment, and a long modification will cause the carrier granules 30 to agglomerate such that the resistivity increases. Therefore, there is a comparatively preferred modification time for the modification on the carrier granules 30 (i.e., time t1 in the figure). This time is related to the specific material and morphology of the carrier granules 30, which will not be specifically limited. FIG. 8 only shows the tendency.

As can be seen from a “curve of resistivity-grafting time”, as the grafting time is prolonged, the resistivity exhibits a decreasing tendency. This indicates that the longer the grafting time is, the more second functional groups are grafted on the surface of the carrier granules 30, the better the dispersivity is, and thus the lower resistivity the conductive adhesive composition 01 formed has. As the time is prolonged, the falling tendency of this curve tends to be smooth. This means that, for the carrier granules 30 made of a specific material, the capability of grafting second functional groups on their surfaces is finite, and the resistivity will not be infinitely decreased with increasing time.

Likewise, as can be seen from a “curve of resistivity-adsorption time of gold balls”, as the adsorption time of gold balls is prolonged, the resistivity exhibits a decreasing tendency. This indicates that the gold balls are dispersed into the primary adhesive material 10 by virtue of the carrier granules 30, and the agglomeration of the gold balls per se is reduced such that the resistivity of the conductive adhesive composition 01 formed is decreased. As the time is prolonged, the falling tendency of this curve also tends to be smooth. This means that, for the carrier granules 30 made of a specific material, the capability of adsorbing the conductive particles 20 is finite, and the resistivity will not be infinitely decreased with increasing time.

Based on that, the embodiments of the present disclosure further provide a sealant 02. As shown in FIG. 9, the sealant 02 comprising a photo-polymerizing agent 03 and the conductive adhesive composition 01 described above.

Here, the photo-polymerizing agent 03 means that it can absorb energy of ultraviolet UV when irradiated by the ultraviolet UV, so as to generate active radicals or cations, such that the sealant 02 is finally cured due to a series of photo-polymerization reactions taking place within the sealant 02.

The photo-polymerizing agent can comprise but is not limited to alkyl phenones (e.g., α,α-diethoxy acetophenone, α-hydroxy alkyl phenones, α-amino alkyl phenones); acylphosphine oxides (arylacylphosphine oxides, dibenzoylphenyl phosphine oxides); benzophenones (benzophenone, 2,4-dihydroxy benzophenone, Michler's ketone); thioxanthones (sulfo-propoxy thioxanthone, isopropyl thioxanthone) and so on.

Furthermore, the embodiments of the present disclosure further provide a display panel. The display panel comprises an upper substrate and a lower substrate disposed oppositely, as well as the sealant 02. The sealant 02 is located between the upper substrate and the lower substrate.

The display panel can be any products or components having a display function such as a liquid crystal panel, an organic electroluminescent display panel, electronic paper, handset, tablet computer and so on.

It should be noted that, all figures of the present disclosure are brief schematic views of the conductive adhesive composition and the method for producing the same. They are only used to reflect structures related to the inventive concept in order to clearly describe the solution. Other existing structures unrelated to the inventive concept are not reflected or only partly reflected in the drawings.

What is described above is only specific implementation of the present disclosure, but the protection scope of the present disclosure shall not be limited thereto. Any variants or substitutions easily conceivable for a skilled person familiar with this technical field within the technical scope disclosed by the present disclosure shall fall within the protection scope of the present disclosure. Therefore, the protection scope of the present disclosure shall be subjected to the protection scope of the claims.

1. A conductive adhesive composition, comprising:
a primary adhesive material; and
carrier granules dispersed in the primary adhesive material and having conductive particles adsorbed thereon.

2. The conductive adhesive composition according to claim 1, wherein the carrier granules comprise on their surfaces first functional groups which are organophilic.

3. The conductive adhesive composition according to claim 2, wherein
the primary adhesive material is composed of a resin material; and
the first functional groups comprise at least one of amino, mercapto, vinyl, epoxy, cyano and methacryloyloxy.

4. The conductive adhesive composition according to claim 1, wherein the carrier granules comprise on their surfaces second functional groups carrying positive charges or negative charges.

5. The conductive adhesive composition according to claim 1, wherein the conductive particles are made of at least one material of gold, silver, copper, aluminum, nickel and tin.

6. The conductive adhesive composition according to claim 1, wherein the conductive particles are spherical.

7. The conductive adhesive composition according to claim 1, wherein the carrier granules are made of at least one material of carbon black, activated carbon, carbon nanotubes and molecular sieves.

8. A method for producing a conductive adhesive composition, comprising:
forming carrier granules having conductive particles adsorbed thereon; and
dispersing the carrier granules having conductive particles adsorbed thereon into the primary adhesive material.

9. The method according to claim 8, wherein the step of forming carrier granules having conductive particles adsorbed thereon comprises:
dispersing the conductive particles into a first solvent to form a dispersion liquid of conductive particles;
dispersing the carrier granules into the dispersion liquid of conductive particles to adsorb the conductive particles;
separating the carrier granules from the dispersion liquid of conductive particles; and
drying the carrier granules to obtain the carrier granules having conductive particles adsorbed thereon.

10. The method according to claim 8, further comprising:
prior to forming carrier granules having conductive particles adsorbed thereon, performing modification treatment on the carrier granules to expose adsorption channels within the carrier granules.

11. The method according to claim 10, wherein the step of performing modification treatment on the carrier granules to expose adsorption channels within the carrier granules comprises:
dispersing the carrier granules into an acidic solvent;
separating the carrier granules from the acidic solvent;
washing the carrier granules until pH value is stable; and
drying the carrier granules to obtain the carrier granules that have undergone modification treatment.

12. The method according to claim 8, further comprising:
prior to dispersing the carrier granules having conductive particles adsorbed thereon into the primary adhesive material, performing a grafting treatment on the carrier granules such that the carrier granules comprise on their surfaces first functional groups which are organophilic.

13. The method according to claim 12, wherein the step of performing a grafting treatment on the carrier granules such that the carrier granules comprise on their surfaces first functional groups which are organophilic comprises:
dispersing the carrier granules into a second solvent;
heating the second solvent in which the carrier granules have been dispersed;
adding a reaction solution having first functional groups into the second solvent;
separating the carrier granules; and
drying the carrier granules to obtain the carrier granules having the first functional groups on their surfaces.

14. The method according to claim 8, further comprising:
prior to dispersing the carrier granules having conductive particles adsorbed thereon into the primary adhesive material, performing a grafting treatment on the carrier granules such that the carrier granules comprise on their surfaces second functional groups which carry positive charges or negative charges.

15. The method according to claim 14, wherein the step of performing a grafting treatment on the carrier granules such that the carrier granules comprise on their surfaces second functional groups which carry positive charges or negative charges comprises:
dispersing the carrier granules into a third solvent;
heating the third solvent in which the carrier granules have been dispersed;
adding a reaction solution having second functional groups into the third solvent;
separating the carrier granules; and
drying the carrier granules to obtain the carrier granules having the second functional groups on their surfaces.

16. A sealant, comprising:
a photo-polymerizing agent; and
the conductive adhesive composition according to claim 1.

17. A display panel, comprising:
an upper substrate and a lower substrate disposed oppositely; and
the sealant according to claim 16,
wherein the sealant is located between the upper substrate and the lower substrate.

18. The sealant according to claim 16, wherein the carrier granules comprise on their surfaces first functional groups which are organophilic.

19. The sealant according to claim 18, wherein
the primary adhesive material is composed of a resin material; and
the first functional groups comprise at least one of amino, mercapto, vinyl, epoxy, cyano and methacryloyloxy.

20. The sealant according to claim 16, wherein the carrier granules comprise on their surfaces second functional groups carrying positive charges or negative charges.
